(19) United States
(12) Patent Application Publication
(10) Pub. No.: US 2006/0286249 A1
(43) Pub. Date: Dec. 21, 2006

(54) Semi-finished food product

(76) Inventors: Renoo Avinash Blindt, Shambrook (GB); Bronwyn Elliott, Shambrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/555,839

(22) PCT Filed: Dec. 16, 2003
(86) PCT No.: PCT/EP03/14510

§ 371 Date: Nov. 3, 2005

(30) Foreign Application Priority Data
May 27, 2003 (EP) 03253320.0
May 27, 2003 (EP) 03253321.8
May 27, 2003 (EP) 03253322.6

(51) Int. Cl. A23L 1/06

(52) U.S. Cl. 426/573

(57) ABSTRACT

A semi-finished food product is provided for preparing the gelled part of terrins, mousses, cakes and the like. It is fluid at 20° C., has a continuous aqueous phase and comprises particles dispersed in the aqueous phase. The product comprises 0.1-5 wt % non-starch polysaccharide gelling agent, 1-11 wt % protein, 3.5-30 wt % fat and 50-95 wt % water. It has a viscosity at 20° C. of less than 20 Pa·s at a shear rate of 50 s-1 and a viscosity at 90° C. of less than 3 Pa·s at a shear rate of 50s-1. The particles have a mean particle size D[3,2] of 3.5-50 microns. At least half of the protein and half of the fat contained in the product are contained in composite particles.

The invention relates to a semi-finished food product. Both for the preparation of food products at home and in a commercial setting, there is a growing need of semi-finished food products with which high quality consumable end-products can easily be prepared. The standards that such semi-finished food products must meet are continuously raised. In particular there should be a low risk of failure, the time required to prepare the end product should be short and the resulting end product should have very good organoleptic properties. A further requirement which can be hard to reconcile with the other demands, is that the semi-finished food product should be versatile, i.e. a single semi-finished food product can be used for the preparation of a wide range of different consumable end-products. The present invention is concerned with a versatile semi-finished food product that can be used for preparing a wide range of high quality tarts, terrins, mousses, quiches, paté's and the like, quickly and easily.

The invention provides a semi-finished food product that is fluid at 20° C., has a continuous aqueous phase and comprises particles dispersed in the aqueous phase, which product comprises 0.1-5 wt % non-starch polysaccharide gelling agent, 1-11 wt % protein, 3.5-30 wt % fat and 50-95 wt % water, which product has a viscosity at 20° C. of less than 20 Pa·s at a shear rate of 50 s⁻¹ and a viscosity at 90° C. of less than 3 Pa·s at a shear rate of 50 s⁻¹, wherein the particles have a mean particle size D[3,2] of 3.5-50 microns and wherein at least half of the protein and at least half of the fat contained in the product are contained in composite particles.

We have found that such semi-finished food product is very convenient to handle and notably allows the preparation of consumable end-products remarkably quickly and with remarkably good taste and mouthfeel.

The semi-finished food product is preferably packed in containers. Its physical structure is stable for at least 24 hour. Preferably the product is stable for at least 1 week. If the product is packed in containers, it is preferably stable for at least 1 month, more preferably at least 3 months, both physically and microbiologically. This can be achieved for example by applying heat treatment, homogenisation and preparing the product as a sheared gel, and preferably packing it aseptically.

The product should be fluid at 20° C., i.e. it should be in a mobile condition. In other words, it should not be a solid at that temperature. Specifically it should not be a macroscopically set gel. If a beaker with product is put on its side and if then, eventually, the product will flow, it is fluid. Typically, most soft fresh cheeses, cream cheese e.g. Philadelphia® cream cheese, gelatin pudding, semi-finished food product like QimiQ® (see examples), the gelled part of cheese cake and the like, are not fluid at 20° C.

The viscosity of the product at high temperature and at ambient temperature should not be too high. Otherwise the product would become difficult to handle and it would be difficult to mix taste or flavour imparting components into the semi-finished food product. These properties also have an impact on the organoleptic properties of the end-product prepared with the semi-finished product. For example, a very viscous product at ambient or high temperature is likely to impart a thick, sticky mouthfeel to the consumable end-product.

The mean particle size D[3,2], also referred to as the Sauter mean, should be between 3.5 and 50 microns. If the particle size is either too small or too large, we found that the consumable end product is likely to have a tough, rubbery mouthfeel, an optimum being achievable in the intermediate range indicated above. Too big particles are also likely to result in separation of the product, in particular in fat separation, and or in a grainy texture in the consumable product prepared with it.

By composite particles are meant particles that include at least protein and fat, besides water. Preferably they also include non-starch polysaccharide gelling agent.

The structure of the product can suitably be determined by methods known persé. For example, whether a product has a continuous aqueous phase can be determined by measuring the electrical conductivity or by means of microscopy. The particle composition can be observed by means of spectral scanning confocal microscopy and optical microscopy e.g. as described in G. van Dalen, J. Microsc. (2002), 208, 116-133, see in particular page 118. To improve the clarity of the pictures taken with optical microscopy it may be useful to dilute the sample, e.g. by gently stirring it 1-to-1 with water. D[3,2] indicates the surface to volume mean diameter, see e.g. T. Allen, (1981), Particle Size Measurement, Chapter 4, Particle Size, Shape and Distribution, 3^{rd} edition, Powder Technology Series published by Chapman Hall. It can be measured with a Mastersizer X Long Bend with Software: V2.19, updated with part no: PSW0003/2.19. The parameter settings are:

Range lens: 300 mm

Beam Length: 2.40 mm

Sampler MS1

Presentation: 2NAD (particle refractive index=(1.4564, 0.0000); Dispersent refractive index=1.330)

Analysis Model: polydisperse

Modification none

We do not wish to be bound by theory but we believe that in the preparation of the semi-finished product, e.g. when cooling the composition while shearing it to obtain a stable, fluid product with the indicated particle size that is not too viscous, first the protein begins to aggregate and includes fat in doing so. In a next stage the gelling agent associates itself with the protein-fat aggregates and thereby consolidates the ingredients in composite particles. Once the non-starch polysaccharide gelling agent has completely developed its structure, it is stable under normal storage conditions and prevents the particles from growing bigger or parts of it breaking free again. This microstructure, we believe, provides the surprisingly convenient macroscopic properties of the semi-finished food product and imparts the combination of quick setting and very good organoleptic properties to the consumable end product.

If the same raw materials were combined in a different manner, e.g. by cold mixing an agar/water sheared gel with a source of protein and fat, e.g. soft fresh cheese, milk and cream, then spectral scanning confocal microscopy would show that most of the fat would be contained in separate fat particles, not in composite particles. Much of the protein would be contained in separate protein particles. The amount of composite particles, and consequently the proportion of protein and fat in those composite particles, would be relatively low. Optical microscopy would show agar particles separate from the protein and fat. A semi-finished product prepared in this manner would probably not have a physically stable structure. The fat would probably separate and form a concentrated layer or “fat lakes” at the top of the product. The consumable end-product would not, we believe, have good organoleptic properties; it would have a tough or rubbery mouthfeel. Its structure might even be visibly inhomogeneous due to the destabilisation and separation in the semi-finished product.

We believe that without protein present, fat would not associate with gelling agent in complex particles. We further believe the presence of both protein and fat in the composite particles to be necessary for the desired taste and mouthfeel in the consumable end-product.

Alternatively, if the semi-finished product had the same overall chemical composition but were a block with a macroscopic gel structure, the product would suffer from syneresis and would be inconvenient to handle. It is probable that there would be problems with fat separation and the consumable end-product prepared with it, would probably have a rubbery mouthfeel.

The Sauter mean D[3,2] of the particles in the semi-finished product is preferably 5-30 microns, more preferably 7-20 microns. The viscosity at 20° C. and 50 s⁻¹ is preferably less than 10 Pa·s more preferably less than 5 Pa·s. The viscosity at 90° C. and 50 s⁻¹ is preferably less than 2 Pa·s, more preferably less than 1 Pa·s. On the other hand, the product should preferably not be very thin either. That might make it difficult to incorporate taste or flavour imparting components or pieces and keep them dispersed throughout the product. Accordingly, the viscosity at 20° C. and 50 s⁻¹, is preferably at least 0.1 Pa·s, more preferably at least 0.5 Pa·s. At 90° C. and 50 s⁻¹, the viscosity is preferably at least 0.01 Pa·s, more preferably at least 0.05 Pa·s. The viscosity at 20° C. and at 90° C. can suitably be measured on a Haake VT550 using concentric cylinder geometry—MV2 system. A curve of viscosity (Pa·s) versus shear rate (s⁻¹) is obtained for each of the samples at the specified temperatures. The shear rate range over which the viscosity is measured is 0.99 to 500 s⁻¹. See e.g. Barnes, Hutton and Walters, (1989), An introduction to Rheology, Chapter 2, Viscosity, publisher Elsevier. A plot of log of viscosity versus log of shear rate is constructed and the linear part of this curve is fitted with the power law model. The resulting power law equation is then used to calculate the viscosity of the sample at a shear rate of 50 s⁻¹.

Of the protein contained in the semi-finished food product, preferably at least 60 wt %, more preferably at least 70 wt %, especially at least 75 wt % is contained in the composite particles. Of the fat contained in the semi-finished food product, preferably at least 60 wt %, more preferably at least 70 wt %, especially at least 75 wt % is contained in the composite particles. Image analysis techniques in combination with e.g. confocal microscopy can be used in estimating the proportion of fat or protein contained in composite particles.

The use of thickeners that raise the viscosity at high temperature is preferably avoided. Usually to prepare the consumable end-product, the semi-finished food product is heated and then transferred into a mould, e.g. a cup or a pastry shell, optionally after one or more food components have been stirred in, to allow the gel to set. This would be made more difficult if the composition became very viscous upon the heating. Accordingly, the product preferably does not contain substantial amounts of hydroxypropylmethylcellulose or methylcellulose. More preferably the content of these cellulose derivatives in the semi-finished food product is 0-0.1 wt %. Most preferably the semi-finished food product does not contain these cellulose derivatives at all.

The semi-finished product can have a creamy, rich taste profile, yet it can be sufficiently neutral and subtle to be able to provide an excellent base for the preparation of both sweet and savoury flavoured end-products. These end-products can be mildly and subtly flavoured or have a strong, pronounced profile. This can be obtained by mixing taste-imparting substances, flavours and/or concentrates with the semi-finished product. For example, fresh fruit or fruit preservatives, chocolate flakes, vanilla etc can be used, optionally together with e.g. some sucrose for making sweet cake or pie fillings or e.g. desserts. Alternatively, bouillon, flaked Parmesan cheese, fish paste, pieces of vegetables and/or herbs and spices or other savoury materials can be included to make savoury pate's, terrins, quiches and the like.

In a preferred embodiment the semi-finished food product is a sheared gel. Sheared gels, also referred to as microgels, have been described in the literature. EP 355 908 describes preparations constituting thermo-reversible sheared gels and their preparation. The resulting product is a fluid which can be stored indefinitely in its mobile state but which can be returned to its normal more rigid state by heating through the transition temperature of said composition, whereafter the heated solution will form a normal gel on cooling under quiescent conditions. EP 432 835 describes sheared gel preparations that are chemically set.

A sheared gel is a gel that has been sheared during setting of the gel to provide a gel in a mobile condition. As far as relevant for the present invention, a gel obtained by allowing the gel to set under quiescent conditions has a storage modulus G¹ at 20° C. that is typically at least 2 times as high as the storage modulus at 20° C. of the corresponding sheared gel made from the same composition by applying shear during the setting of the gel. Often G¹ at 20° C. of the gel set under quiescent conditions is more than 3 times as high as G¹ of the corresponding sheared gel at 20° C. Quiescent conditions means the absence of any agitation. Agitation encompasses actions such as shearing, stirring and shaking.

The storage modulus G¹ is suitably determined with a controlled stress rheometer from Rheometrics or equivalent apparatus with 35 mm parallel plates and a gap of 1 mm and water bath, wherein the sample is allowed 10 minutes to equilibrate and the frequency of oscillation is 1 Hz and the stress is 5 N/m2. Further details are described in EP 355 908 and “Viscoelastic Properties of Polymers” by J. D. Ferry, Chapter 1, pages 4-16 Std Book Number 471257745, published by J. Wiley & Sons Inc. For measuring the storage modulus G¹ at temperature T the sample is equilibrated at that temperature T without precedent heating to above the transition temperature.

A thermo-reversible sheared gel is a sheared gel based on a thermo-reversible gelling agent, i.e. a gelling agent that does not form a gel structure above a certain temperature but will do so at lower temperature provided sufficient gelling agent is present, i.e. at a concentration above the critical concentration. The critical concentration of a gelling agent in a particular composition can be calculated from measurement of the storage modulus of a series of samples containing different concentrations of gelling agent as described in Br. Polymer J. 17, (1985), 164.

If a thermo-reversible sheared gel is heated again to above the transition temperature and then cooled to e.g. ambient or refrigerator temperature under quiescent conditions a solid gel is obtained that has lost its mobility.

The transition temperature of a thermo-reversible gel is the temperature at which, upon slow temperature increase, the ordered form, be it of microscopical or macroscopical size, has disappeared completely. The transition temperature can be measured by means of differential scanning calorimetry.

The semi-finished food product should comprise 1-11 wt % protein. Preferably the protein is globular protein, especially dairy protein, vegetable globular protein or a combination thereof. Preferred vegetable globular proteins are soy protein and pea protein and combinations thereof. Most preferably the globular protein is dairy protein, the protein of soft fresh cheese being particularly preferred. Further information on globular proteins is given in Food Science, Nutrition and Health 5^{th} ed, Brian Fox and Allan Cameron, (1989), publisher Edward Arnold. The amount of protein, in particular of globular protein, in the semi-finished food product is preferably 2.5-9 wt %.

Another source of dairy protein that is preferably included in the semi-finished product is cream or milk or a combination thereof. In this manner, a suitable amount of fat can also be included in the product. The milk may for example be whole milk or partially or wholly skimmed milk. The milk may be partially or wholly reconstituted milk. Part or all of the milk fat may have been replaced by fat of vegetable origin. The cream may be dairy cream or part or all of the fat of the cream may have been replaced by fat of vegetable origin.

Fat indicates compositions consisting predominantly of triglycerides. They may be liquid, solid or semi-solid at ambient temperatures. Apart from the fat sources described above, materials that can suitably be used as fat in the semi-finished food product include milk fat, coconut fat, sunflower oil, soybean oil, Canola oils and similar oils having a low erucic acid content derived from rapeseed varieties, olive oil, palm oil, fractions thereof and combinations of two or more thereof. The fat can conveniently be incorporated during the preparation of the semi-finished food product e.g. using a homogenization step.

The components included in the semi-finished food product should be such that the product has a fat content of 3.5-30 wt %, preferably 10-25 wt %, more preferably 14-20 wt %.

If so desired, water may be incorporated in the product. Preferably however, the amount of water included as such does not exceed 40 wt % of the semi-finished food product. More preferably it does not exceed 35 wt % of the semi-finished product. The water content of the product should be 50-95 wt %. preferably the water content of the product is 65-85 wt %.

For an optimal product the combined amount of fat and water is suitably chosen to be 80-96 wt % of the product, preferably 85-95 wt %. The pH of the semi-finished product is preferably 4.2-5.2, more preferably 4.3-4.9. If so desired, food acid may be included to adjust the pH. For example citric acid may be included in the semi-finished food product.

The semi-finished food product may include carbohydrate but preferably the carbohydrate content of the product is less than 15 wt %. More preferably it is less than 10 wt %. Some carbohydrate may be contained in the cheese, milk and/or cream and the gelling agent that may be included in the semi-finished food product. Preferably no component is deliberately included in the product that is rich in carbohydrate. It is especially preferred not to include sucrose or corn syrup or the like. Such carbohydrate sources other than dairy components as described above and the gelling agent may adversely affect the versatility of the product and/or the texture and mouthfeel of the consumable end-product prepared with it. It may also adversely affect the setting characteristics of the consumable end-product.

The semi-finished food product preferably contains less than 2 wt % starch. More preferably, it is substantially free of starch. Preferably the product is substantially free of gelatin. It is further preferred for the product to be substantially free of egg yolk. By “substantially free of” is meant that the substance to which the expression relates, if present at all, is only present at such a low amount that a typical consumer can not tell the difference compared with the same product that does not contain that substance. In such comparison, the two products should be offered to the consumer sequentially with a wash-out period of 1 hour in between. Preferably the semi-finished food product does not contain egg yolk at all. It is also preferred that it does not contain gelatin at all. It is furthermore preferred that it does not contain starch at all. Each of these materials if present, may increase the risk of failure in the preparation of the consumable end-product. They may adversely affect the versatility of the semi-finished food product, e.g. by the influence on the texture and/or the taste and/or the setting properties, but also for product safety or religious reasons. Furthermore, the interaction of anyone of these materials with the polysaccharide gelling agent may adversely affect the structure of the semi-finished food product or of the consumable end-product. Such mixed biopolymer systems may suffer from a variety of defects. Phase separation may occur and syneresis problems may arise. The materials may also cause an undesired change in the structure of the semi-finished food product during storage. Accordingly, the presence of egg yolk, gelatin and starch is preferably avoided completely.

The semi-finished food product should include 0.1-5 wt % non-starch, polysaccharide gelling agent. It includes preferably 0.2-4 wt %, more preferably 0.3-2 wt % of non-starch, polysaccharide gelling agent. Preferably the gelling agent is a thermo-reversible gelling agent, i.e. the gel can be caused to melt or to set by raising or lowering the temperature, respectively. Preferably the gelling agent is selected from the group consisting of agar, gellan, agarose, furcelleran, kappa carrageenan, iota carrageenan, and combinations of two or more thereof. Most preferably the gelling agent is agar. For optimal texture, versatility and mouthfeel, it is preferred that the semi-finished food product is substantially free of non-gelling, thickening hydrocolloids. More preferably it is free of non-gelling, thickening hydrocolloids. For example the product should preferably not contain locust bean gum or guar gum. In a particularly preferred embodiment, the semi-finished food product is substantially free of gelling agents other than agar. Most preferably the product contains agar and no other polysaccharide hydrocolloid.

Preferably at least half of the non-starch polysaccharide gelling agent contained in the product is contained in the composite particles. More preferably at least 60 wt %, especially at least 70 wt %, most preferably at least 75 wt % of the non-starch polysaccharide gelling agent contained in the product is contained in the composite particles.

The semi-finished food product may further include other food grade materials, e.g. preservatives, emulsifiers, protein preparations e.g. soy isolate, and the like. However, it is particularly preferred that at least 90 wt % of the semi-finished food product consists of dairy components, gelling agent and optionally water and/or vegetable fat.

The semi-finished food product can suitably be prepared as follows. All components to be included are combined, a thermo-reversible gelling agent is used and the composition is heated to above the transition temperature of the gelling agent. Preferably the composition is homogenised. The composition is sheared during cooling. Typically cooling and shearing should be applied until the temperature of the composition is below 20° C. to obtain a product that remains fluid even though the gel has set. If after preparation of the product, nevertheless a macroscopic gel network develops, this can be addressed by cooling and shearing the composition to a somewhat lower temperature, e.g. down to 15° C. For the preparation of the consumable end-product, the composition can be caused to set as a gelled layer or block by heating it and allowing it to cool down again under quiescent conditions. It is not usually necessary for the preparation of the end-product to heat the semi-finished food product to above the transition temperature. It is usually preferable not to heat the product too high. Usually very good results can be obtained by quickly heating the composition to a temperature of 80 or 85° C., e.g. in a microwave oven, and stopping the heat treatment as soon as that temperature has been reached.

If in preparing the semi-finished food product the particle size obtained is too high, this can be remedied by applying more shear e.g. during the cooling of the product. It can be particularly effective to apply more shear during the higher temperature part of the cooling step, e.g. at 80-60° C. If the particles become too small, less shear should be applied.

Too small particles may also be caused by the presence of materials that cause the viscosity to be high at high temperature. To reduce the viscosity, especially at high temperature, and stimulate the formation of less small particles, the amount of sugars and thickeners and the like in the product should be reduced. If this has insufficient effect, or as an alternative, water can be added.

The semi-finished food product is preferably packed in containers. The containers can suitably be packs with a volume between 150 ml and 1 tonne. The preferred pack size is from 0.5 to 10 liters. E.g. at 1 or 2 l pack size, Tetrapak® or Combibloc® cartons can be used. For 10 l size, bag-in-box packing can be suitable. For larger packs, e.g. 200 or 300 l drums or 1 tonne Pallacon® containers can suitably be used. Packing is preferably done aseptically after pasteurisation or sterilisation to obtain a good shelflife. If so desired, the product may be stored frozen. It can be used for preparing the end-product directly from frozen, or it can be allowed to warm up to ambient temperature, e.g. 20° C. and the fluid consistency to be returned, before preparing the end product.

The customer wishing to prepare the end product can do so by stirring into the semi-finished food product any components he or she wishes to incorporate and allowing the composition to set, possibly after filling it into a pastry base or other mould. Preferably the end product is prepared by heating the composition to a temperature of e.g. about 80° C., mixing in any additional components desired before or after the heating and allowing the composition to set under quiescent conditions in a mould to obtain the consumable end product.

Throughout this specification all parts, percentages and ratios are by weight unless otherwise indicated. Except with respect to the preparation of the consumable end products described in the examples, all parts, percentages and ratios relate to the weight of the semi-finished food product, unless specifically indicated otherwise. Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

### EXAMPLE 1

A professional chef prepared mini coffee cheesecakes using his usual recipe and preparation method as follows.

Biscuit base mix was heated on a stove for 5 minutes. Base was then placed into 8 small moulds.

Recipe for the gelled part of 8 mini cheesecakes:

15 g gelatine

2 teaspoons liquid coffee concentrate

150 g soft brown sugar

450 g Philadelphia® cream cheese

300 ml whipping cream

300 ml water

The sugar and part of the water were put into a pan. The gelatine powder was sprinkled over the cold water and stirred in. The mixture was boiled and the remainder of the water was brought to the boil and added as well. This was stirred continuously. It took 11 minutes to dissolve the gelatine. This mixture was set aside and left to cool down for a few minutes.

The cream cheese and coffee concentrate were put in a food processor and mixed briefly. It was then transferred to a bowl. The cream was whipped in a Kenwood™ mixer. The gelatine mixture was mixed into the cream cheese mix. Then the whipped cream was folded into the mixture. The resulting composition was poured onto the biscuit base in the moulds. The products were put in a refrigerator to set.

The total preparation time was 30 minutes. The minimum setting time to obtain products that could reasonably be consumed was 1 hour and 45 minutes. The chef commented that he usually left the product overnight to be sure that it had sufficiently set at the time of consumption.

The following composition was used for the preparation of a semi-finished food product according to the present invention: 54 parts by weight (pbw) Philadelphia® cream cheese ex Kraft Foods, UK

1 pbw agar

19 pbw Elmlea® single (a cream ex Van den Bergh Foods Ltd UK consisting of a blend of buttermilk and vegetable oils. The fat content was 13%)

26 pbw water

The semi-finished food product was prepared as follows. The cream and water were put in a beaker and mixed. The agar was cold dispersed in the mixture and stirred for about 5 minutes. The mixture and the cream cheese were put in a jacketed vessel provided with a stirrer and connected to a hot water supply. The lid was closed. The stirrer was operated at low speed and the heating was turned on. The temperature was raised to 90° C. and the stirrer speed was increased to 350 rpm. Then the jacket of the vessel was connected to a cold water supply. Stirring was continued until the temperature of the composition had reduced to 15° C. The composition was then poured into sterile plastic bottles of 500 ml. The lid was screwed on and the bottles were stored in a refrigerator until further use.

The semi-finished food product was a sheared gel and it contained 4 wt % dairy protein. The mono- and disaccharide content was 3 wt %. Most of this was lactose. The fat content was 15 wt %. The water content was 76 wt %. The combined amount of water and fat present in the sheared gel was 91 wt %. The pH was 5.0. After several days storage the sheared gel was still mobile. It had a viscous, easily spoonable consistency.

The sheared gel was used to make a coffee cheesecake with the following recipe:

500 g sheared gel

50 g soft brown sugar

2 teaspoons coffee concentrate

Moulds with biscuit base mix were prepared as described above. The sugar, coffee concentrate and sheared gel were put in a ceramic bowl and briefly mixed. The mixture was heated in a microwave at 650 watt for 5 minutes. It was briefly stirred two times during the heating. After 5 minutes the composition had reached a temperature of 81° C. It was briefly whisked with a hand whisk. The mix was poured onto the biscuit base in the moulds and the cheesecakes were put in a refrigerator. The preparation time had been only 8 minutes. After 10 minutes in the refrigerator the gel had set and the cheesecakes were ready for consumption.

The chef judged the cheesecakes prepared from the sheared gel to have very good texture, taste and flavor. They were as good as the cheesecakes prepared with his traditional recipe. The preparation time, setting time, amount of work and the number of utensils used and to be cleaned afterwards were all markedly lower for the recipe based on the semi-finished product.

### EXAMPLE 2

A semi-finished food product according to the present invention was prepared from the following composition:

| | | |
|---|---|---|
| 54 | pbw | “American style full fat soft cheese” ex |
| | | Yoplait, UK. (This is a cream cheese alternative, |
| | | suitable for vegetarians). |
| 0.5 | pbw | agar |
| 19 | pbw | of a low fat dairy cream alternative consisting |
| | | of a blend of skimmed milk and vegetable fat. |
| | | The fat content was 10%.) |
| 25 | pbw | water |
| 1 | pbw | K-sorbate solution (10% solution) |
| 0.11 | pbw | citric acid. |

The product was prepared as follows. The cream and the cream cheese alternative were placed in a mixer with the water, sorbate and citric acid. The mixer was turned on. The agar was dispersed into the mixture. The resulting mixture was fed into a scraped surface heat exchanger (SSHE) and pre-heated to 85° C. From here the product was fed into a single stage homogeniser at 500 psi. Next it was pasteurized in another SSHE at 110° C. for 12 sec. The flow rate of the process was 120 l/hr. The product was cooled with water to 45° C. in a SSHE and then to 14° C. by a glycol cooled SSHE. It was stored in a sealed sterile tank before being aseptically packed using a Metal box SL1 aseptic pot filler. The product was filled into 150 ml plastic pots sealed with a foil lid and stamped with the product name and the date of manufacture.

The product contained 3 wt % milk protein, 4 wt % carbohydrate most of which was lactose, 17 wt % fat and 74 wt % water. The pH was 4.5.

A leaflet was prepared with Product Handling Guidelines for the users. The user was instructed to heat the product to a minimum of 75° C. for one minute, to activate the setting process. Ingredients could be added before or after the heating process. For cold serve products it was recommended to chill for 15 minutes before serving. Hot serve products would also set in 15 minutes and could be hot-held.

### EXAMPLE 3

A smoked fish based gelled product was prepared from the following recipe.

250 g QimiQ® (QimiQ contains 1 wt % gelatin and otherwise only contains dairy cream and skimmed milk. QimiQ® was obtained from Hama Foodservice, Austria.)

125 g smoked mackerel

125 g dairy cream

½ teaspoon of finely chopped dill tips

lemon juice

white pepper

salt

mustard

The QimiQ was whisked till smooth. The smoked fish was finely chopped and added together with the seasoning and dill tips. The cream was whipped and folded into the mixture. The mixture was then filled into a mould and put in the refrigerator. The preparation time was 10 minutes (excluding cutting the fish and the dill tips).

A similar product was made using the semi-finished food product described in example 1. In the recipe 375 g of the semi-finished product was used instead of the QimiQ and the cream. The semi-finished product did not need to be whisked. After all components had been combined in a bowl, the bowl was put in a microwave and heated for 3 minutes at full capacity. The temperature reached was 72° C. The composition was then poured in the mould and placed in the refrigerator. The preparation time was 5 minutes (excluding cutting the fish and the dill tips).

After the products had been allowed to set for 60 minutes, they were removed from the refrigerator. The product based on the semi-finished product had fully set. It could easily be de-moulded and it retained the shape of the mould. It could be cut and its texture was smooth and creamy.

The product prepared with QimiQ had not yet set and could not be de-moulded. The volume of product obtained from the same weight of recipe was less, suggesting that it had retained less air during the preparation.

### EXAMPLE 4

A chocolate based gelled product was prepared from the following recipe:

560 g semi-finished food product as described in example 1

100 g chocolate chips

3 dessert spoons crystal sugar

1 teaspoon rum

The components were combined, briefly mixed and heated in a microwave at full power for 5 minutes. The composition reached a temperature of 80° C. The chocolate chips had molten. The composition was then briefly mixed through and poured into 4 small moulds and put in the refrigerator for 60 minutes. After 20 minutes in the refrigerator the product was already fully set. It could be easily de-moulded and it retained the shape of the container. It could be cut and its texture was smooth and creamy.

### EXAMPLE 5

Trials were done using different types and amounts of gelling agent and salt.

Sheared Gel Compositions:

| | | |
|---|---|---|
| 53.7 | pbw | full fat soft cheese (28% fat) as described in |
| | | example 2 |
| 18.8 | pbw | Elmlea ® single (see example 1) |
| 25.82 | pbw | water |
| 0.01 | pbw | citric acid |
| 0.1 | pbw | K-sorbate (10% solution) |
| | | gelling agent |
| | | salt |

The type and amount of gelling agent and salt were as follows

| | |
|---|---|
| Ex 5a: | 0.5 pbw Kappa carrageenan |
| | 0.3 pbw NaCl (10% solution in water) |
| Ex 5b: | 0.6 pbw iota carrageenan |
| | 0.5 pbw CaCl₂.2H₂O (10% solution) |
| Ex 5c: | 0.6 pbw gellan |
| | 0.5 pbw CaCl₂.2H₂O (10% solution) |
| Ex 5d: | 0.6 pbw Kappa carrageenan with 25% furcelleran |
| | 0.6 pbw CaCl₂.2H₂O (10% solution) |

Sheared Gel Preparation:

The K-sorbate, water, Elmlea® and citric acid were placed in a jacketed heating vessel. The gelling agent was added slowly with stirring and stirring was continued for 5 minutes. The soft cheese was added and the mix heated to 50° C. Then the salt was added. The mixture was heated to 90° C., kept at that temperature for 10 minutes and then cooled down over 2 hours to below 15° C. Stirring was continued through the whole preparation. The sheared gel was stored at 5° C.

Preparation of Raspberry Mousse:

125 g of the sheared gel was heated in a microwave oven to 80° C. After the heating 20 g raspberry puree and 15 g sugar were stirred in. The mixture was poured in a small bowl and placed in a refrigerator at 5° C. to allow it to set.

The sheared gels obtained were relatively thick. Their viscosities at 20° C. and 50 s⁻¹ were in the range of 2.4-3.3 Pa·s. The raspberry mousse was somewhat salty. Overall, the sheared gels were not as convenient to use as the sheared gel based on agar. The taste and texture of the gelled food products obtained were not as good as those obtained with sheared gel based on agar.

### EXAMPLE 6

A series of trials were done with 2 different types of soft fresh cheese. Their composition was as follows

| soft fresh cheese | | |
|---|---|---|
| composition (wt %) | Milklink ®* | Blackmore Vale ®** |
| water | 54 | 60 |
| fat | 31 | 31 |
| protein | 6.4 | 8.6 |
| carbohydrate | 6.0 | trace |

*Milklink ® full fat soft cheese, a soft fresh cheese, is available from Milklink Ltd, Staplemead Creamery, Frome, Somerset UK
**Blackmore Vale ® American style full fat soft cheese, a soft fresh cheese, is available from Blackmore Vale Farm Cheese Ltd, Shaftesbury, Dorset, UK.

Sheared gels constituting semi-finished products according to the present invention were prepared using the following recipes, expressed in pbw

| | Example | | | | |
|---|---|---|---|---|---|
| | 6A | 6B | 6C | 6D | 6E |
| Milklink ® | 51 | 51 | 48 | 54 | — |
| Blackmore Vale ® | — | — | — | — | 51 |
| Skimmed milk | 18.9 | 18.9 | 18.9 | 18.9 | 18.9 |
| Dairy cream | — | 2.44 | — | — | 2.44 |
| (48% fat) | | | | | |
| Water | 29.5 | 27.05 | 32.5 | 26.5 | 27.05 |
| Agar | 0.5 | 0.5 | 0.5 | 0.5 | 0.5 |
| Citric acid | 0.085 | 0.11 | 0.085 | 0.09 | 0.14 |

The sheared gels were prepared as described in example 5, mutatis mutandis. All products obtained had good consistency. They were convenient to use. Their composition was as follows (expressed as wt %)

| | Example | | | | |
|---|---|---|---|---|---|
| | 6A | 6B | 6C | 6D | 6E |
| Water | 74 | 73 | 76 | 73 | 76 |
| Protein | 3.9 | 3.9 | 3.7 | 4.1 | 5.0 |
| Fat | 16 | 17 | 15 | 17 | 17 |
| Carbohydrate | 4.5 | 4.5 | 4.3 | 4.6 | 1.5 |

These sheared gels can suitably be used to prepare gelled food products, for example raspberry mousse, using the recipe and preparation method described in example 5.

For comparison, 2 products were prepared with the same composition as used for sample 6E. In comparison 6EC1, powdered agar was used and all components making up the composition were mixed cold. In comparison 6EC2, a sheared gel was prepared of 2% agar in water, incorporating all agar to be used. This sheared gel was cold mixed with the balance of the composition.

Samples of product 6E and of 6EC1 and 6EC2 were heated in a microwave oven to 80° C. and allowed to set under quiescent conditions.

Samples of the 3 products before the heat treatment were investigated with spectral scanning confocal microscopy and with optical microscopy (without dilution). The samples after the heat treatment and setting were investigated sensorically.

For the confocal microscopy investigation a Leica TCSSP was used. The samples were stained (simultaneously for fat and protein) with Nile Blue. One drop of 0.1% Aqueous Nile Blue solution was gently stirred into 1 ml of product. The sample was placed in a microscope cavity slide for viewing by confocal microscopy. The Objective was 63×1.4 na oil immersion (160 and 80 micron field widths.) Fat was detected using an argon laser with excitation at 488 nm and measuring emission at 510-570 nm. Protein was detected using a He—Ne laser with excitation at 633 nm and measuring emission at 650-700 nm.

For the optical microscopy a Reichart Polyvar light microscope was used with a 40× objective to visualize the products. To prepare the slides a small amount of unstained sample was gently pressed between a microscope slide and cover glass and viewed under phase contrast optics.

For sample 6E the confocal microscopy showed the very large majority of the protein and fat to be contained in composite particles with a size in the range of 5-20 micron. There were only a few separate fat droplets, which had a size of about 5 micron or less. Separate protein particles were hardly present; any such particles appeared to be very small, e.g. 2 micron or less.

The sample 6EC1 was inhomogeneous in the microscope well. A layer in the upper part of the sample was investigated. Most if not all particles were quite small, about 5 micron or less. Many of those particles consisted solely of fat. More than half of the fat appeared to be contained in those separate fat particles. A substantial portion of the particles appeared to consist solely of protein.

The picture of sample 6EC2 was similar to that of 6EC1 except that it seemed to contain more particles, i.e. was more densely packed, and it contained some aggregated fat particles in the order of 10 micron or more. This sample contained still more small particles that seemed to consist purely of protein.

In the optical microscopy picture of sample 6EC2, agar particles of size 20-30 micron that appeared to be separate from the other particles, were visible. In sample 6E, only small agar parts could be seen that seemed to be attached to the protein/fat particles. This is consistent with the agar having associated itself with protein/fat aggregates during preparation. For sample 6EC1 no agar could be observed at all. This was consistent with the separate observation for that sample that the agar appeared to sink to the bottom of the container quickly.

For sample 6EC1 the separation problem was also noticable in the product after the heat treatment and setting. The resulting gels were variable in gel strength, presumably reflecting the variation in the amount of agar that ended up in the sample being heated. The sample also suffered from fat separation. The sample 6E gave good results. Sample 6EC2 had a less good mouthfeel than sample 6E; it tasted rubbery and tough. This sample showed fat separation too.

### EXAMPLE 7

Milklink® soft fresh cheese as described in example 6 was used.

The recipe for the semi finished food product was

| | | |
|---|---|---|
| 54 | pbw | Milklink ® soft fresh cheese |
| 4.1 | pbw | homogenised double cream (48% fat) |
| 41 | pbw | skim milk |
| 0.5 | pbw | powdered agar |
| 0.21 | pbw | citric acid |
| 0.1 | pbw | potassium sorbate |

In a cheese-making factory the cheese was taken from the production line in pumpable condition, cooled to a temperature of 6-13° C. and fed to a mixing tank fitted with an agitator, Silveston mixer and recirculation loop. The other ingredients were also fed to the mixing tank. The mixture was blended until it was smooth and liquid. The final temperature was 6° C. The premix obtained was packed into a 1 tonne Pallacon® and blast chilled to 4° C. The mixture was then transported refrigerated to a processing facility where it was pumped into a mixing tank and mixed for 5 minutes. It was then sterilised by passage through a UHT heat exchanger, cooled under shear to below 20° C. and then packed aseptically into cartons.

Alternatively, the composition can be cooled to 4° C. by passage through a plate heat exchanger before transferring it into the Pallacon®.

### EXAMPLE 8

Semi-finished food products according to the invention with code 8A to 8E were produced using the compositions as described in example 6 for samples 6A to 6E, respectively, but the preparation method as described in example 2 was applied, mutatis mutandis.

For the resulting semi-finished food products D[3,2] was measured using a Mastersizer X Long Bend as described above. The sample was added to a waterbath supplied with and connected to the Masersizer X, with stirring at 1700 rpm, till the obscuration was between 10 and 30%. A volume distribution was obtained and D[3,2] determined.

The viscosity at 20° C. and 50 s⁻¹ and at 90° C. and 50 s⁻¹ were measured using a Haake VT 550 as described above.

The following results were obtained:

| | 8A | 8B | 8C | 8D | 8E |
|---|---|---|---|---|---|
| D[3, 2] (micron) | 11.3 | 10.9 | 12.6 | 10.9 | 11.7 |
| Viscosity at 20° C. | 1.0 | 1.3 | 0.8 | 1.4 | 0.9 |
| and 50 s⁻¹ (Pa · s) | | | | | |
| Viscosity at 90° C. | 0.13 | 0.12 | 0.09 | 0.13 | 0.16 |
| and 50 s⁻¹ (Pa · s) | | | | | |

1. A semi-finished food product that is fluid at 20° C., has a continuous aqueous phase and comprises particles dispersed in the aqueous phase, which product comprises 0.1-5 wt % non-starch polysaccharide gelling agent, 1-11 wt % protein, 3.5-30 wt % fat and 50-95 wt % water, which product has a viscosity at 20° C. of less than 20 Pa·s at a shear rate of 50 s⁻¹ and a viscosity at 90° C. of less than 3 Pa·s at a shear rate of 50 s⁻¹, wherein the particles have a mean particle size D[3,2] of 3.5-50 microns and wherein at least half of the protein and at least half of the fat contained in the product are contained in composite particles.

2. A semi-finished food product according to claim 1 wherein at least half of the gelling agent contained in the product is contained in the composite particles.

3. A semi-finished food product according to claim 1 or claim 2 wherein the protein content is 2.5-9 wt %.

4. A semi-finished food product according to any one of claims 1-3, wherein the protein is globular protein.

5. A semi-finished food product according to any one of claims 1-4, wherein the fat content is 10-25 wt %.

6. A semi-finished food product according to any one of claims 1-5, wherein the water content is 65-85 wt %.

7. A semi-finished food product according to any one of claims 1-6, wherein the viscosity at a temperature of 20° C. and a shear rate of 50 s⁻¹ is less than 10 Pa·s.

8. A semi-finished food product according to any one of claims 1-7, wherein the viscosity at a temperature of 90° C. and a shear rate of 50 s⁻¹ is less than 2 Pa·s.

9. A semi-finished food product according to any one of claims 1-8, wherein the mean particle size D[3,2] is 5-30 microns.

10. A semi-finished food product according to any one of claims 1-9, wherein the gelling agent is a thermo-reversible gelling agent.

11. A semi-finished food product according to any one of claims 1-10, wherein the gelling agent is selected from the group consisting of agar, kappa carrageenan, iota carrageenan, gellan, agarose, furcelleran and a combination of two or more thereof.

12. A semi-finished food product according to any one of claims 1-11 that is substantially free of non-gelling, thickening hydrocolloid.

13. A semi-finished food product according to any one of claims 1-12 that is substantially free of gelling agents other than agar.

14. A semi-finished food product according to any one of claims 1-13, wherein at least 60 wt % of the protein contained in the product is contained in the composite particles.

15. A semi-finished food product according to claim 14, wherein at least 75 wt % of the protein contained in the product is contained in the composite particles.

16. A semi-finished food product according to any one of claims 1-15, wherein at least 60 wt % of the fat contained in the product is contained in the composite particles.

17. A semi-finished food product according to claim 16, wherein at least 75 wt % of the fat contained in the product is contained in the composite particles.

18. A semi-finished food product according to any one of claims 1-17 that comprises less than 15 wt % carbohydrates.

19. A semi finished food product according to any one of claims 1-18 that is substantially free of starch.
